(19) United States
(12) Patent Application Publication
(10) Pub. No.: US 2005/0099653 A1
(43) Pub. Date: May 12, 2005

(54) Print terminal

(75) Inventor: Yoshiki Kawaoka, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/984,968

(22) Filed: Nov. 10, 2004

(30) Foreign Application Priority Data
Nov. 12, 2003 (JP) NO. 2003-382503

(51) Int. Cl. G06F 15/00; H04B 7/00; H04L 9/00

(52) U.S. Cl. 358/1.15; 358/402; 455/41.3; 713/170

(57) ABSTRACT

The print terminal according to the present invention comprises a communication device for communicating with a server saving an e-mail message attached with an image sent from a user's mobile terminal, an information obtaining device for obtaining identification information for identifying an image attached to the e-mail message from the mobile terminal, an image capturing device for capturing the image attached to the e-mail message from the server via the communication device based on the identification information obtained by the information obtaining device, and a printing device for printing the image captured by the image capturing device.

### BACKGROUND OF THE INVENTION

1. Field of the Invention

The present invention relates to a print terminal, and more specifically to a print terminal for printing an image taken by a digital camera cellular phone in the shop.

2. Description of the Related Art

A conventional print terminal of this type is described in Japanese Patent Application Publication No. 2003-203036.

When a user wants to print an image that he attached to an e-mail message and sent to a server with this print terminal, the user inputs his identification information including his cellular phone number (an e-mail address) through a monitor attached with a touch panel of the print terminal. The print terminal captures an image attached to the user's e-mail message from a server via a communication line interface to storage based on the user's identification information, while displaying a list of images on a monitor attached with a touch panel. When the user selects an image to print on the monitor and puts charged amount of cash into a coin machine, a print engine inside the print terminal prints out the selected image.

### SUMMARY OF THE INVENTION

However, when a user inputs his identification information including his cellular phone number, mail address, and a personal identification number in the print terminal described in Japanese Patent Application Publication No. 2003-203036, the user has to manipulate a touch panel attached to a print terminal to input his identification information, which is troublesome and might lead an input error and the like.

The present invention is adapted in view of the above situation, and intends to provide a print terminal enabling a user to easily input necessary information from the user's cellular phone when the user downloads his image from a server.

To achieve the above object, a first aspect of a print terminal according to the present invention comprises a communication device for communicating with a server saving an e-mail message attached with an image sent from a user's mobile terminal; an information obtaining device for obtaining identification information for identifying an image attached to the e-mail message from the cellular phone; an image capturing device for capturing the image attached to the e-mail message from the server via the communication device based on the identification information obtained by the information obtaining device; and a printing device for printing the image captured by the image capturing device.

Thus, in order to print an image attached to an e-mail message saved in the server, the user has an information obtaining device of a print terminal at the shop obtain identification information for identifying an image to be printed from the user's mobile terminal. The print terminal that obtained the identification information captures the image attached to the e-mail message from the server via the communication device based on the obtained identification information. The server saves e-mail messages attached with images for a certain period. When the server receives a request to obtain an image based on the identification information from the print terminal, it sends out the image (or the e-mail message attached with the image) corresponding to the identification information.

The image captured in this manner is printed out with the printing device. Although the number of copies defaults to one, it can be set to any number.

A second aspect of a print terminal according to the present invention is the first aspect of a print terminal, further comprising a display device for displaying a list of the captured images; and a print image selection device for selecting an image to be printed from the list of images displayed on the display device, wherein the printing device prints an image selected by the print image selection device.

When the image capturing device captures a single image, the image is displayed on the display device. When the image capturing device captures a plurality of images, a list of the images is displayed on the display device. When an image to be printed is selected through the print image selection device, the selected image is printed out with the printing device.

A third aspect of a print terminal according to the present invention is the first or the second aspect of a print terminal, wherein the identification information for identifying the image is information including a receipt number and an authentication code sent from the server to the mobile terminal.

A fourth aspect of a print terminal according to a the present invention is any aspects from the first to the third aspects of a print terminal, wherein the information obtaining device receives print ordering information for an image attached to an e-mail message along with identification information for identifying the image from the mobile terminal, and wherein the printing device prints the image captured by the image capturing device according to the received print ordering information.

Print ordering information captured along with identification information by the information obtaining device is the information including the number of copies, the size of a sheet, and a type of paper to be printed on (normal paper/seal paper) for the image identified by the identification information.

A fifth aspect of a print terminal according to the present invention is any aspects from the first to the fourth aspects of a print terminal, wherein the information obtaining device is a close range wireless communication device for wirelessly receiving the identification information from the mobile terminal. An infrared communication device complying with IrDA (Infrared Data Association) standard, a wireless communication device complying with Bluetooth standard for close range communicating with low power consumption, and wireless LAN (IEEE802.11b/g, etc.) are employed for the close range wireless communication device.

A sixth aspect of a print terminal according to the present invention is any aspects from the first to the fifth aspects of a print terminal, wherein the information obtaining device comprises an image pickup device for picking up the identification information displayed on a display device of the mobile terminal; and a decoding device for decoding identification information from the image obtained by the image pickup device.

When the identification information is displayed as character information on a display device of a cellular phone, the decoding device can capture the identification information by performing character recognition on the image obtained by the image pickup device with OCR (Optical Character Recognition). When the identification information is displayed as one dimension or two dimension barcode or the like on a display device of a cellular phone, the decoding device can capture the identification information by decoding one dimension or two dimension barcode or the like from the image obtained with the image pickup device. This decoding device is effective specifically for a cellular phone without a close range wireless communication device.

A seventh aspect of a print terminal according to the present invention is any aspects from the first to the sixth aspects of a print terminal, wherein the printing device prints characters of an e-mail message along with an image. In other words, the printing device can capture character information in an e-mail message as well as an image from a server, and print the character information and the image.

A eighth aspect of a print terminal according to a the present invention is any aspects from the first to the seventh aspects of a print terminal, further comprising a billing device for charging for printing by the printing device. The billing device may be paying by cash with a coin machine, charging the price to a telephone bill, paying by a credit card or a prepaid card. The printing device prints an image out if the billing device can charge for printing, and then charges for the print.

According to the present invention with the above configuration, when a print terminal prints an image attached to an e-mail message sent from a user's cellular phone to a server, the print terminal can obtain identification information for identifying an image to be printed from a user's cellular phone and download the user's image from a server based on the obtained identification information. Particularly, as the print terminal can obtain the identification information from a user's cellular phone, it can input the identification information easily and correctly.

### BRIEF DESCRIPTION OF THE DRAWINGS

FIG. 1 is a schematic view of an image print system including a print terminal according to the present invention;

FIG. 2 is block diagram illustrating an embodiment of a print terminal according to the present invention;

FIG. 3 is a flowchart illustrating an embodiment of an operation of an image print system;

FIG. 4 is a block diagram illustrating another embodiment of a print terminal according to the present invention; and

FIG. 5 is a plane view of a cellular phone including a monitor screen.

### DETAILED DESCRIPTION OF THE PREFERRED EMBODIMENTS

Now, preferred embodiments of a print terminal according to the present invention will be described in detail with reference to accompanying drawings.

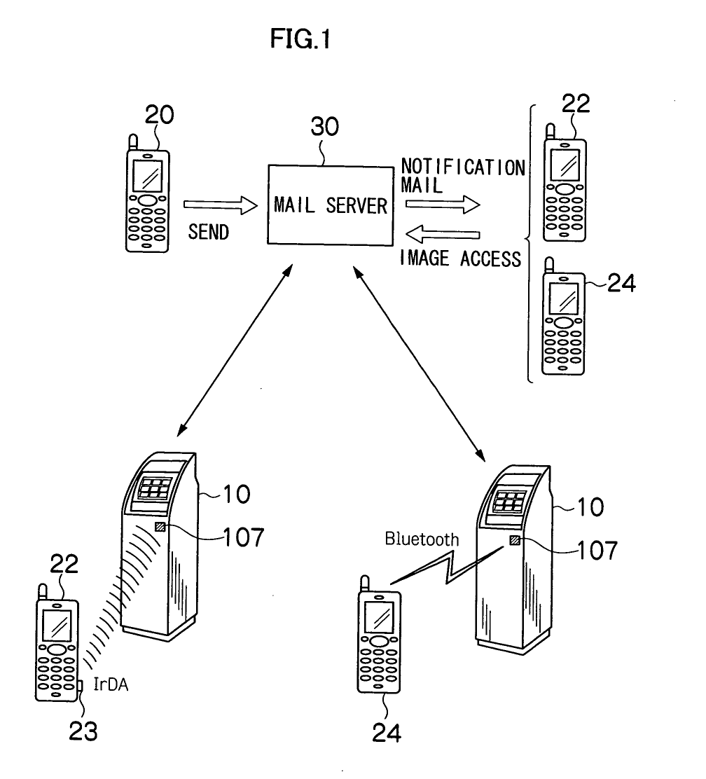

FIG. 1 is a schematic view of an image print system including a print terminal according to the present invention.

As shown in FIG. 1, the image print system includes print terminals 10 set at the shop or the like, DSC (Digital Still Camera) cellular phones with an e-mail function 20, and a mail server 30. The print terminals 10, the DSC cellular phones 20, 22, 24, and the mail server 30 can communicate with each other via a network (not shown).

The print terminal 10 receives an image file attached to an e-mail message mainly from the mail server 30 and prints the image out. This will be described in detail later.

The DSC cellular phones 20, 22, 24 have an image taking function with a digital camera, an e-mail sending/receiving function (including an e-mail message attached with an image file), a liquid crystal monitor for displaying an image and the like, and memory for saving image data and the like.

The mail server 30 has an e-mail sending/receiving function, a mail-box function, an e-mail administrating function.

When a user sends an image from the user's DSC cellular phone 20 to others' DSC cellular phones 22, 24, or a personal computer 40, the user shoots an object with the DSC cellular phone 20 and captures the image into the cellular phone. The image can also be captured into the cellular phone via external interface.

The image captured into the cellular phone 20 is sent together with destination information including a mail address, a mail account, a mail password for each of the destined DSC cellular phones 22, 24 by using an e-mail message (attached with a file) function of the cellular phone.

An e-mail message attached with an image file sent in this manner is saved in a mail box allocated for each mail account for e-mail messages on a hard disk of the mail server 30. The mail server 30 notifies a corresponding user that an e-mail message is received. A user of the DSC cellular phones 22, 24 can access the mail server 30, download the e-mail message for the user, and read the content.

If an e-mail message is attached with an image file, users can open the attached file, read in the image information, and view the image by having it displayed on each monitor of the DSC cellular phones 22, 24. The received e-mail message is stored in memory of the DSC cellular phones 22, 24.

In this manner, an image can be exchanged among persons by e-mail.

Next, the print terminal 10 according to the present invention will be described.

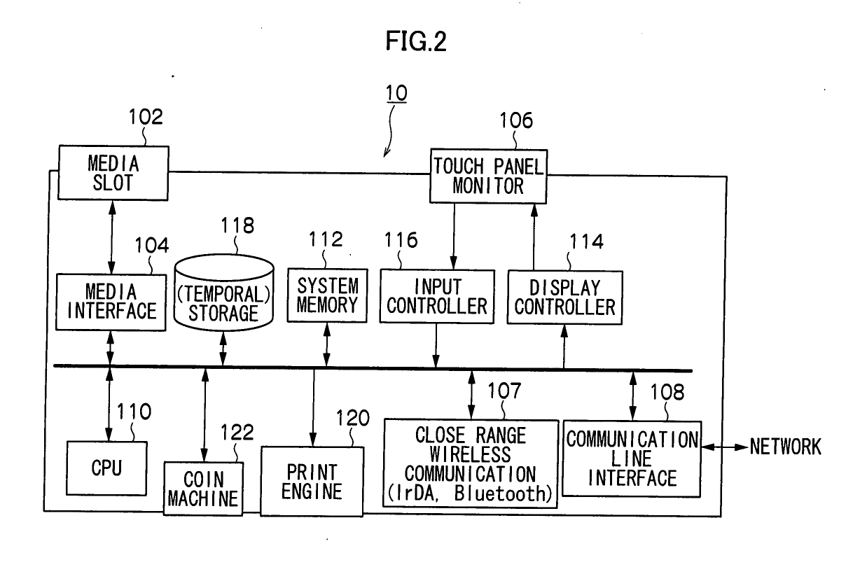

FIG. 2 is a block diagram illustrating an embodiment of the print terminal 10. As shown in FIG. 2, the print terminal 10 is provided with a media slot 102 and a media interface 104 for receiving a recording media such as a smart media, a memory stick, and a compact flash, a touch panel monitor 106, a close range wireless communication device (an infrared communication device complying with IrDA standard and a wireless communication device complying with Bluetooth) 107, and a communication line interface 108 enabling sending/receiving necessary information to/from the mail server 30.

The touch panel monitor 106 displays a list of images stored on a recording media inserted into the media slot 102 or images received from the mail server 30, and operation buttons for manipulating the touch panel.

The print terminal 10 is provided with a central processing unit (CPU) 110 for controlling the whole of the print terminal 10, a system memory 112 including ROM containing a program to operate the CPU 110 and RAM serving as a work space when the CPU 110 is processing, a display controller 114 for outputting information to be displayed on the touch panel monitor 106, and an input controller 116 for inputting print setting information including selection of an image to be printed, the number of copies (one for default) by using the touch panel monitor 106.

The print terminal 10 is provided with a storage 118 for temporally storing information such as an image or print setting information captured from a record media inserted into the media slot 102 or from the mail server 30, a print engine 120 for printing an image stored in the storage 118 based on print setting information, and a coin machine 122.

Next, an operation of the image print system including the above print terminal 10 will be described.

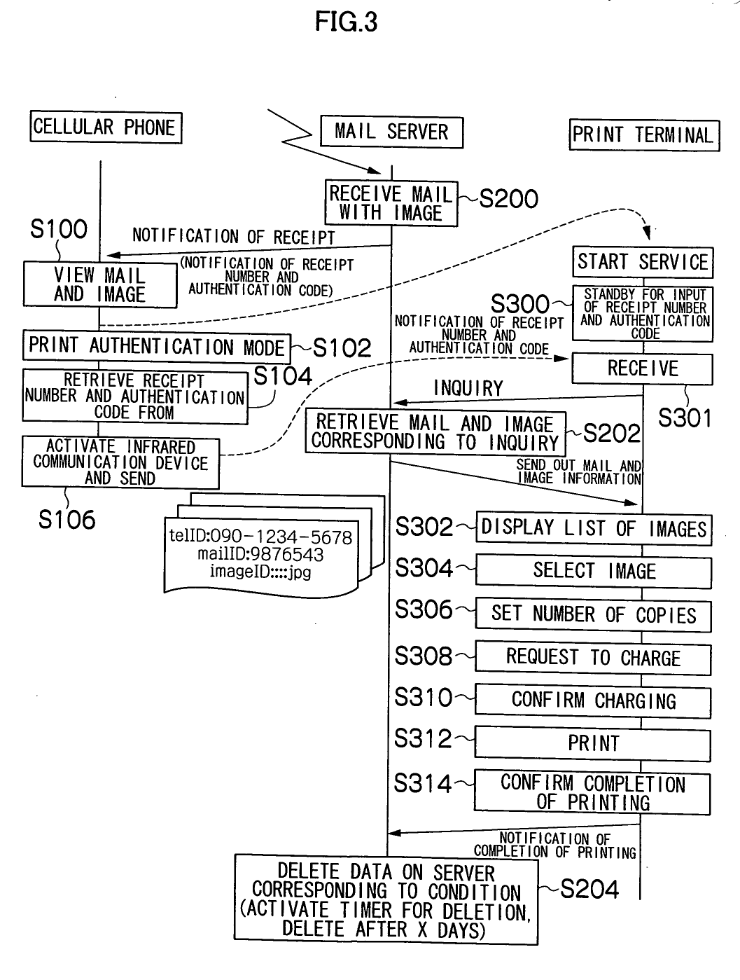

FIG. 3 is a flowchart illustrating an embodiment of an operation of the image print system.

As mentioned above, when the mail server 30 receives an e-mail message (an e-mail message attached with an image) (step S200), it notifies a destined user that an e-mail message is received. The mail server 30 concurrently notifies a receipt number and an authentication code that are referred to in order to use a print service described later.

A user who received this notification can access the mail server 30, download an e-mail message for the user, and view the content of the mail or the image (step S 100).

When a user prints the image received by e-mail on the print terminal 10, the user first sets a mode (a print authentication mode) for sending the receipt number and authentication code from a cellular phone (step S 102). When the print authentication mode is set, the cellular phone retrieves the receipt number and authentication code from the notification mail received from the mail server 30 (step S104), and then activates an infrared communication device included in the cellular phone and sends the retrieved receipt number and authentication code complying with IrDA communication standard (step S106). The cellular phone 22 shown in FIG. 1 includes an infrared communication device 23 and sends the receipt number and authentication code from the infrared communication device 23 by infrared communication to the close range wireless communication device 107 (in this case, an infrared receiver) of the print terminal 10.

The print terminal 10 is usually in a standby state for input of the receipt number and authentication code from any cellular phone (step S300). When the close range wireless communication device 107 receives the receipt number and authentication code sent by infrared communication from the cellular phone (step S301), the processes described below are performed.

The print terminal 10 inquires the mail server 30 via the communication line interface 108 whether any e-mail message (an e-mail message attached with an image) for the user is stored in a mail box or not based on the received receipt number and authentication code.

The mail server 30 stores an e-mail message in a mail box for a certain period (for example, for several weeks) even after a user accesses the mail server 30 with a cellular phone and transfers the e-mail message. If an e-mail message corresponding to the inquiry is in the mail box, the mail server 30 retrieves an e-mail message attached with an image and transfers all retrieved e-mail messages attached with images to the print terminal 10 (step S202). The mail server 30 can notify the print terminal 10 where to obtain the attached image file, allowing the print terminal 10 to obtain the file.

As only the image file can be attached to an e-mail message with a cellular phone at present, whether an image is attached to an e-mail message from a cellular phone or not can be determined by checking whether the e-mail message is attached with a file or not. It can also be determined by checking an extension of an attached file.

When the print terminal 10 receives an e-mail message attached with an image for the user from the mail server 30 in a manner described above, it displays a list of the received images on the touch panel monitor 106 (step S302).

The user selects an image he wants to print from the list of images displayed on the touch panel monitor 106 by touching on the touch panel (step S304). The user also sets the number of copies for each image by using ten-keys or the like on the touch panel (step S306). As the number of copies defaults to one, the number of copies is set only when a user wants to print two or more copies.

When the abovementioned selection of an image and setting of the number of copies are performed, the print terminal 10 requests to charge for the print (step S308). When the print terminal 10 confirms that the amount thrown into the coin machine 122 is the charged amount or more (step S310), it performs printing of the selected image with the print engine 120 (step S312). When the print terminal 10 confirms the completion of printing all the images (step S314), it settles the bill and discharges the printed image, while notifying the mail server 30 of the completion of the printing.

When the mail server 30 receives the notification of the completion of the printing, it deletes all e-mail messages attached with images sent to the print terminal 10 or only the e-mail messages attached with images corresponding to the printed image from the mail box even if the saving period is not expired (step S204). The mail server 30 can be adapted to activate a timer for deletion and deletes an e-mail message attached with an image after a predetermined period (a period shorter than a usual saving period), when it receives the notification of the completion of the printing.

Although the receipt number and authentication code is sent from the cellular phone 22 by infrared communication to the print terminal 10 in this embodiment, the present invention is not limited to this and can be adapted to wirelessly send the receipt number and authentication code in a communication manner complying with Bluetooth standard from the cellular phone 24 when the cellular phone 24 has a close range wireless communication device complying with Bluetooth standard as the cellular phone 24 shown in FIG. 1. Close range wireless communication manner is not limited to that used in the embodiment, and it can use other wireless LAN.

When an image is printed, a type of print can be selected appropriately from a normal print, which is a simple print with no frame, a print including an e-mail message, which prints a single image on a sheet with characters from the e-mail messages in the margin, a multi-print for printing a plurality of images on a single sheet, a composed print for printing the image composed with a prepared template image, and the like.

The type of print can be selected on the screen for selecting a type of print for a print terminal. Prices for printing a sheet may vary depending on the type of print.

Paying by cash with a coin machine is used for a billing method in this embodiment, but the present invention is not limited to this method. A billing method can be charging the price to a telephone bill or paying by a credit card or a prepaid card.

Next, a print terminal 10′ which can capture a receipt number and authentication code from a cellular phone without the above close range wireless communication device.

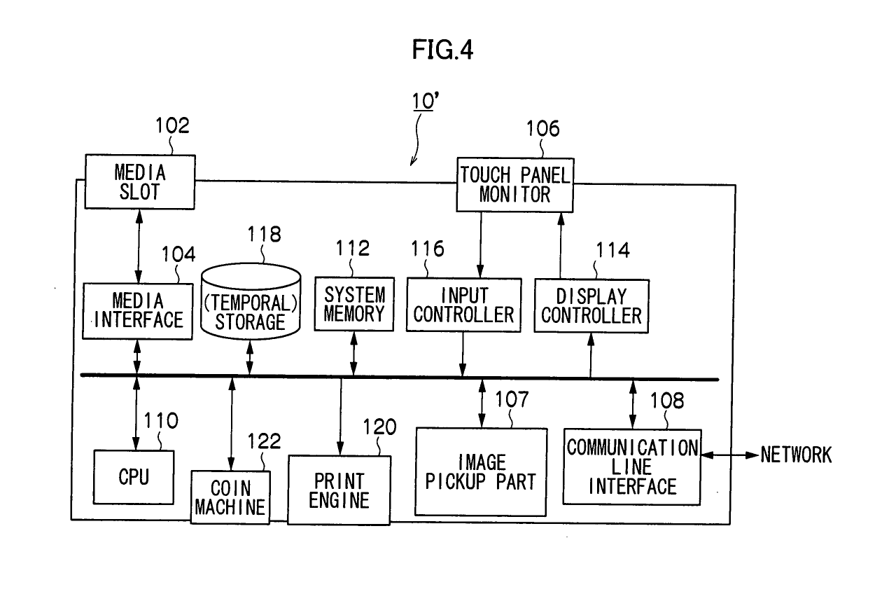

FIG. 4 is a block diagram illustrating an embodiment of the print terminal 10′. The parts same as those in FIG. 2 are denoted by the same numerals and their detailed descriptions are omitted.

The print terminal 10′ shown in FIG. 4 is provided with an image pickup part 109 instead of the close range wireless communication device 107 in the print terminal 10 shown in FIG. 2.

The image pickup part 109 picks up the image of a monitor screen on a cellular phone and reads character information or a one dimension barcode indicating a receipt number and authentication code displayed on the monitor screen or a two dimension barcode such as QR code (Quick Response code).

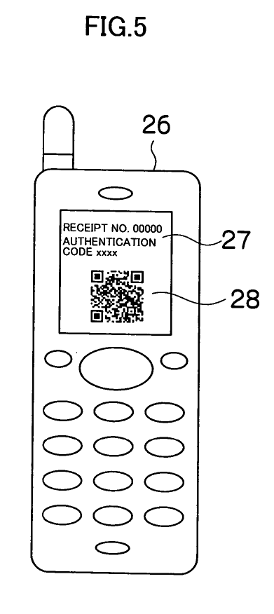

Thus, in order to print an image received by e-mail with the print terminal 10′, a user has a character information 27 and a two-dimension barcode 28 indicating a receipt number and authentication code notified from the mail server 30 to a cellular phone 26 displayed on a liquid crystal monitor of a cellular phone 26 as shown in FIG. 5, and has this monitor screen read by the image pickup part 109 of the print terminal 10′.

The image pickup part 109 has an Optical Character Recognition function (OCR function) or a decoding function of two dimension barcode. The image pickup part 109 recognizes the character information 27 from an image of the picked up monitor screen or decodes the two-dimension barcode 28 and obtains a receipt number and authentication code. Process after obtaining the receipt number and authentication code and before printing is performed in the same manner as that of the print terminal 10 described above.

Although this embodiment is described with the case that a user who received an e-mail message attached with an image prints the image saved in the mail server 30 with the print terminals 10, 10′, the present invention is not limited to this embodiment and can be adapted to the case that a user uploads an image by e-mail to a service server, which saves an image and accepts an order for printing, and prints the image by a print terminal. As a matter of course, the service server notifies the cellular phone which sent the e-mail of the receipt number and authentication code.

Identification information which a print terminal obtains from a user's cellular phone is not limited to the receipt number and authentication code in this embodiment and can be any identification information that can identify an image attached to an e-mail message, such as a user's mail address or a cellular phone number or information on an authentication code, or any combination of them.

Print ordering information such as the number of copies, the size of a sheet, a type of print, and a type of paper to be printed on (normal paper/seal paper) is not limited to be input using a touch panel on a print terminal. It can be captured through a user's cellular phone by close range wireless communication.

Although a user's mobile terminal is exemplified by a cellular phone in this embodiment, other terminal including personal digital assistant (PDA) with an e-mail sending/receiving function can be used.

1. A print terminal comprising:
a communication device for communicating with a server saving an e-mail message attached with an image sent from a user's mobile terminal;
an information obtaining device for obtaining identification information for identifying an image attached to the e-mail message from the mobile terminal;
an image capturing device for capturing the image attached to the e-mail message from the server via the communication device based on the identification information obtained by the information obtaining device; and
a printing device for printing the image captured by the image capturing device.

2. The print terminal according to claim 1, further comprising:
a display device for displaying a list of the captured images; and
a print image selection device for selecting an image to be printed from the list of images displayed on the display device,
wherein the printing device prints an image selected by the print image selection device.

3. The print terminal according to claim 1, wherein the identification information for identifying the image is information comprising a receipt number and an authentication code sent from the server to the mobile terminal.

4. The print terminal according to claim 1, wherein the information obtaining device receives print ordering information for an image attached to an e-mail message along with identification information for identifying the image from the mobile terminal, and wherein the printing device prints the image captured by the image capturing device according to the received print ordering information.

5. The print terminal according to claim 1, wherein the information obtaining device is a close range wireless communication device for wirelessly receiving the identification information from the mobile terminal.

6. The print terminal according to claim 1, wherein the information obtaining device comprises an image pickup device for picking up the identification information displayed on a display device of the mobile terminal; and a decoding device for decoding identification information from the image obtained by the image pickup device.

7. The print terminal according to claim 1, wherein the printing device prints characters of an e-mail message along with an image.

8. The print terminal according to claim 1, further comprising a billing device for charging for printing by the printing device.
